(19) United States
(12) Patent Application Publication
(10) Pub. No.: US 2026/0350762 A1
(43) Pub. Date: Nov. 5, 2026

(54) SHARPENING PROCESSING METHOD AND APPARATUS, AND DEVICE AND STORAGE MEDIUM

(71) Applicant: Douyin Vision Co., Ltd., Beijing (CN)

(72) Inventors: Yingxue PANG, Beijing (CN); Shijie ZHAO, Beijing (CN)

(21) Appl. No.: 19/486,900

(22) PCT Filed: May 23, 2024
(86) PCT No.: PCT/CN2024/094919

§ 371 Date: Nov. 21, 2025

(30) Foreign Application Priority Data
May 24, 2023 (CN) 202310594642.8

(51) Int. Cl. G06T 5/73; G06T 5/60; G06T 7/00

(52) U.S. Cl. CPC G06T 5/73; G06T 5/60; G06T 7/0002; G06T 2207/10016; G06T 2207/20081; G06T 2207/20084; G06T 2207/30168

(57) ABSTRACT

Embodiments of the present disclosure provide a sharpening method and apparatus. a device and a storage medium. The method includes: obtaining a target object to be sharpened; inputting the target object to a target prediction model for prediction of a sharpening intensity, the target prediction model being obtained in advance by training based on a sample object and a sharpening intensity label corresponding to the sample object and the sharpening intensity label being determined based on rate-distortion performance indicator values corresponding to a plurality of preset sharpening intensities; and sharpening the target object based on a target sharpening intensity output by the target prediction model.

The present application claims priority to Chinese Patent Application No. 202310594642.8, filed on May 24, 2023, which is incorporated herein by reference in its entirety as a part of the present application.

### TECHNICAL FIELD

Embodiments of the present disclosure relate to a sharpening method and apparatus, a device, and a storage medium.

### BACKGROUND

With the rapid development of computer technology, it is often necessary to sharpen an object such as an image or a video, to improve quality of the object. However, increasing a sharpening intensity does not mean that the quality of the object can be continuously improved. Use of an excessively high sharpening intensity may deteriorate the quality of the object. Furthermore, bit information of the object can increase as the sharpening intensity increases. As a result, a larger bandwidth may be consumed to transmit the object. As can be seen, there is currently an urgent need for a sharpening method that can effectively balance quality of an object and bandwidth consumption.

### SUMMARY

The present disclosure provides a sharpening method and apparatus, a device, and a storage medium, to effectively balance quality of an object and bandwidth consumption, thereby reducing the bandwidth consumption while improving the quality of the object.

According to a first aspect, an embodiment of the present disclosure provides a sharpening method, including:
obtaining a target object to be sharpened;
inputting the target object to a target prediction model for prediction of a sharpening intensity, wherein the target prediction model is obtained in advance by training based on a sample object and a sharpening intensity label corresponding to the sample object, and the sharpening intensity label is determined based on rate-distortion performance indicator values corresponding to a plurality of preset sharpening intensities; and
sharpening the target object based on a target sharpening intensity output by the target prediction model.

According to a second aspect, an embodiment of the present disclosure further provides a sharpening apparatus, including:
a target object obtaining module, configured to obtain a target object to be sharpened;
a sharpening intensity prediction module, configured to input the target object to a target prediction model for prediction of a sharpening intensity, wherein the target prediction model is obtained in advance by training based on a sample object and a sharpening intensity label corresponding to the sample object, and the sharpening intensity label is determined based on rate-distortion performance indicator values corresponding to a plurality of preset sharpening intensities; and
a sharpening module, configured to sharpen the target object based on a target sharpening intensity output by the target prediction model.

According to a third aspect, an embodiment of the present disclosure further provides an electronic device. The electronic device includes:
one or more processors; and
a storage apparatus, configured to store one or more programs, where
the one or more programs, when executed by the one or more processors, cause the one or more processors to implement the sharpening method according to any one of the embodiments of the present disclosure.

According to a fourth aspect, an embodiment of the present disclosure further provides a storage medium comprising computer-executable instructions, where the computer-executable instructions, when executed by a processor by a computer, are used to perform the sharpening method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale.

FIG. 1 shows a schematic flowchart of a sharpening method according to an embodiment of the present disclosure;

FIG. 2 shows a schematic flowchart of another sharpening method according to an embodiment of the present disclosure;

FIG. 3 shows an example of a rate-distortion curve corresponding to a sample video according to an embodiment of the present disclosure;

FIG. 4 shows a diagram of an example of determining a first performance indicator value according to an embodiment of the present disclosure;

FIG. 5 shows a diagram of an example of determining a second performance indicator value according to an embodiment of the present disclosure;

FIG. 6 shows a diagram of an example of fitting first performance indicator values corresponding to a plurality of preset sharpening intensities according to an embodiment of the present disclosure;

FIG. 7 shows a diagram of an example of fitting second performance indicator values corresponding to a plurality of preset sharpening intensities according to an embodiment of the present disclosure;

FIG. 8 shows a schematic flowchart of still another sharpening method according to an embodiment of the present disclosure;

FIG. 9 shows a diagram of an architecture example of a target prediction model according to an embodiment of the present disclosure;

FIG. 10 shows a schematic structural diagram of a sharpening apparatus according to an embodiment of the present disclosure; and

FIG. 11 shows a schematic structural diagram of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

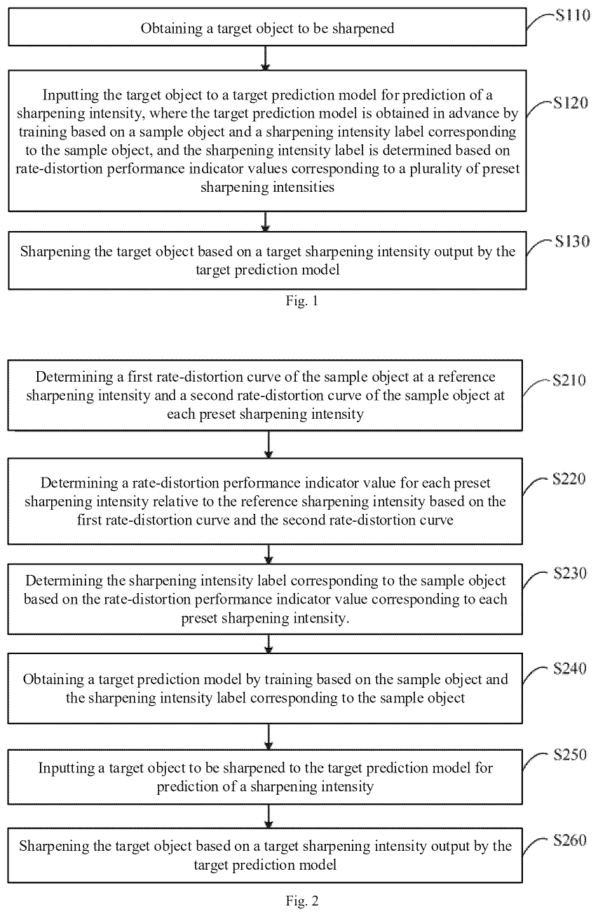

FIG. 1 is a schematic flowchart of a sharpening method according to an embodiment of the present disclosure. This embodiment of the present disclosure is applicable to a situation of sharpening an object such as a video or an image, and in particular, a situation of sharpening an object such as a video or an image before encoding and compression. The method may be performed by a sharpening apparatus. The apparatus may be implemented in the form of software and/or hardware, optionally, by an electronic device, which may be a mobile terminal, a personal computer (PC) terminal, a server, or the like.

As shown in FIG. 1, the sharpening method specifically includes the following steps.

S110: Obtaining a target object to be sharpened.

The target object may be an object that currently requires quality improvement by sharpening. For example, the target object may be, but is not limited to, a target image or a target video. Sharpening highlights textures, overcomes blur, and directs the attention of a user to specific regions, thereby effectively improving quality of an object.

Specifically, if the object to be sharpened is an image, a target image to be sharpened may be obtained, to improve quality of the image by sharpening. If the object to be sharpened is a video, a target video to be sharpened may be obtained, to improve quality of the video by sharpening. For example, an original video may be divided into one or more target videos to be sharpened based on a shooting scene corresponding to each frame of video image in the original video. Each frame of video image in each target video corresponds to the same shooting scene, so as to separately sharpen the target video in each shooting scene, thus ensuring a video sharpening effect and further improving the quality of the video.

S120: Inputting the target object to a target prediction model for prediction of a sharpening intensity, where the target prediction model is obtained in advance by training based on a sample object and a sharpening intensity label corresponding to the sample object, and the sharpening intensity label is determined based on rate-distortion performance indicator values corresponding to a plurality of preset sharpening intensities.

The preset sharpening intensities may be a plurality of discrete sharpening intensities that are set in advance based on service requirements. For example, a sharpening intensity range may be divided based on a sharpening intensity interval, to obtain the plurality of preset sharpening intensities. For example, when the sharpening intensity interval is 0.5, the preset sharpening intensities may include: 0, 0.5, 1.0, 1.5, 2.0, 2.5, and 3.0. A preset sharpening intensity of 0 indicates that no sharpening is performed, and it may be used as a reference sharpening intensity in order to measure a sharpening effect of a preset sharpening intensity that is not 0, that is, to measure quality of a sharpened object and bandwidth consumption compared with the case of no sharpening. A smaller sharpening intensity interval for the preset sharpening intensities reflects more accurate determination of the sharpening intensity label.

The sharpening intensity label is an optimal sharpening intensity that can reduce the bandwidth consumption while effectively improving the quality of the object. The rate-distortion performance indicator values may be used for evaluating a change in the bandwidth consumption or the quality of the object after the object is sharpened. The bandwidth consumption may be represented by bit information of the sharpened object. For example, if the object to be sharpened is a video, the bit information of the object may be video bitrate, i.e., bits per second (bps). If the object to be sharpened is an image, the bit information of the object may be a pixel depth, i.e., bits per pixel (bpp). The larger video bitrate bps or pixel depth bpp leads to a larger bandwidth consumed to transmit the video or the image. The quality of the object may be represented by using a quality assessment indicator. For example, the quality assessment indicator may include: Peak Signal to Noise Ratio (PSNR), Structural Similarity (SSIM), Visual Multimethod Assessment Fusion (VMAF), or the like. It should be noted that smaller bit information and a larger quality assessment indicator value indicate that the sharpened object has higher performance.

Each preset sharpening intensity corresponds to one rate-distortion performance indicator value, which is used for representing the performance of the object sharpened by using the preset sharpening intensity. Each rate-distortion performance indicator value may include: a first performance indicator value or a second performance indicator value. The first performance indicator value may be a bit information change amount of the preset sharpening intensity relative to the reference sharpening intensity when the preset sharpening intensity and the reference sharpening intensity correspond to a same quality. For example, the first performance indicator value means: when an object that is not sharpened (namely, the reference sharpening intensity is 0) has same quality as an object that is sharpened by using the preset sharpening intensity (namely, they have the same quality assessment indicator value), bit information that is saved by the object sharpened by using the preset sharpening intensity compared with the object that is not sharpened (namely, bandwidth consumption that is reduced). For example, the first performance indicator value may be represented by using a Bjontegaard delta-rate (BD-Rate).

The second performance indicator value may be a quality assessment indicator change amount of the preset sharpening intensity relative to the reference sharpening intensity when the preset sharpening intensity and the reference sharpening intensity correspond to the same bit information. For example, the second performance indicator value means: when an object that is not sharpened (namely, the reference sharpening intensity is 0) has the same bit information as an object that is sharpened by using the preset sharpening intensity (namely, they have the same bandwidth consumption), a quality assessment indicator that is increased by the object sharpened by using the preset sharpening intensity compared with the object that is not sharpened (namely, the improved quality of the object). For example, when the quality assessment indicator is the VMAF, the second performance indicator value may be represented by a BD-VMAF.

The target prediction model may be a neural network model used for predicting the optimal sharpening intensity. A network architecture of the target prediction model may be any type of regression prediction network architecture. The sample object and the target object are of the same type. For example, the sample object is a sample image or a sample video. The target prediction model obtained by training based on the sample image can accurately predict the optimal sharpening intensity of the target image. The target prediction model obtained by training based on the sample video can accurately predict the optimal sharpening intensity of the target video.

Specifically, the optimal sharpening intensity corresponding to the sample object may be determined in advance based on the rate-distortion performance indicator value of the sample object at each preset sharpening intensity, and the optimal sharpening intensity may be used as the sharpening intensity label for model training. For example, the rate-distortion performance indicator value corresponding to each preset sharpening intensity may be compared, and a preset sharpening intensity with the highest performance may be used as the sharpening intensity label. Alternatively, curve fitting may be performed based on all the rate-distortion performance indicator values corresponding to all the preset sharpening intensities to obtain a fitted curve between the preset sharpening intensities and the rate-distortion performance indicator values, and a sharpening intensity with the highest performance on the fitted curve may be used as the sharpening intensity label. A prediction model to be trained is trained based on the sample object and the sharpening intensity label corresponding to the sample object, so that the target prediction model obtained after the training is completed has an ability of predicting the optimal sharpening intensity. For example, a training process of the target prediction model is: inputting the sample object to the prediction model to be trained; obtaining a sample sharpening intensity corresponding to the sample object based on an output of the prediction model; determining a training error by using a loss function based on the sample sharpening intensity and the sharpening intensity label, and back-propagating the training error into the prediction model; adjusting a model parameter in the prediction model until a preset convergence condition is met, for example, the number of times of iterations is equal to a preset number of times or a training error change tends to be stable, and determining that the training on the prediction model ends; and using the trained prediction model as the target prediction model. In actual use, the target object to be sharpened is input to the trained target prediction model. The target prediction model may perform network processing on the input target object, and predict and output the optimal sharpening intensity. For example, the target prediction model may extract high-frequency feature information and common image feature information in the input target object, and perform sharpening intensity prediction based on the extracted feature information, thereby implementing frequency-assisted sharpening intensity prediction and further improving accuracy of sharpening intensity prediction.

S130: Sharpening the target object based on a target sharpening intensity output by the target prediction model.

The target sharpening intensity may be the optimal sharpening intensity of the target object, that is, a sharpening intensity that can reduce the bandwidth consumption while improving the quality of the target object. Specifically, a server can sharpen the target object by using the optimal target sharpening intensity output by the target prediction model. After the sharpening, compression encoding is performed on the sharpened target object, and the encoded object is sent to a client, thereby reducing the bandwidth consumption while ensuring the quality of the sharpened target object.

According to the technical solution of this embodiment of the present disclosure, by determining the sharpening intensity label corresponding to the sample object in advance based on the rate-distortion performance indicator values corresponding to the plurality of preset sharpening intensities, the rate-distortion performance indicator values can be used for reflecting the performance of the object sharpened using the preset sharpening intensities, namely, the quality and the bandwidth consumption. Thus, the optimal sharpening intensity that can effectively balance the quality of the object and the bandwidth consumption can be obtained based on the rate-distortion performance indicator values and used as the sharpening intensity label. By training based on the sample object and the sharpening intensity label corresponding to the sample object, the target prediction model that can predict the optimal sharpening intensity can be obtained. The target object to be sharpened is input to the target prediction model for prediction of the sharpening intensity, and the target object is sharpened based on the optimal sharpening intensity output by the target prediction model, thereby improving the quality of the target object and reducing the bandwidth consumption.

FIG. 2 is a schematic flowchart of another sharpening method according to an embodiment of the present disclosure. Based on the above disclosed embodiment, this embodiment of the present disclosure describes a determining process of a sharpening intensity label corresponding to a sample object. Explanations of the terms identical or corresponding to those in the embodiments disclosed above are not repeated herein.

As shown in FIG. 2, the sharpening method specifically includes the following steps.

S210: Determining a first rate-distortion curve of the sample object at a reference sharpening intensity and a second rate-distortion curve of the sample object at each preset sharpening intensity.

The reference sharpening intensity may be a sharpening intensity used as a comparison reference. Quality of an object and bandwidth consumption at each preset sharpening intensity are both compared with quality of the object and bandwidth consumption at the reference sharpening intensity, so that a sharpening intensity with highest performance in all the preset sharpening intensities is obtained. For example, the reference sharpening intensity may be 0, so that a change amount of the quality of the object and a change amount of the bandwidth consumption during each type of sharpening are measured relative to the quality of the object and the bandwidth consumption without sharpening. All the preset sharpening intensities may include or may not include the reference sharpening intensity.

A rate-distortion curve may be a change curve between bit information and a quality assessment indicator value, such as an RD curve. When the sample object is a video object, the bit information is a quantity of bits transmitted per unit time (bps), i.e., a video bitrate. When the sample object is a sample image, the bit information is a quantity of bits corresponding to a single pixel (bpp), namely, a pixel depth. It should be noted that smaller bit information reflects a larger quality assessment indicator value, which means that the sharpened object has higher performance. The first rate-distortion curve may be a rate-distortion curve obtained after the sample object is sharpened by using the reference sharpening intensity. The second rate-distortion curves may be rate-distortion curves obtained after the sample object is sharpened by using the preset sharpening intensities. The preset sharpening intensities are in one-to-one correspondence to the second rate-distortion curves.

Specifically, the process of determining the first rate-distortion curve corresponding to the reference sharpening intensity and the process of determining the second rate-distortion curves corresponding to the preset sharpening intensities are the same, except that the sharpening intensities used are different. For example, after the sample object is sharpened by using the reference sharpening intensity or the preset sharpening intensities, a plurality of pieces of bit information and a plurality of corresponding quality assessment indicator values can be obtained by performing a plurality of compression encoding on a sharpened sample object based on a plurality of different compression ratios. Thus, corresponding rate-distortion curves can be plotted based on all the bit information and all the quality assessment indicator values.

For example, the determining a first rate-distortion curve of the sample object at a reference sharpening intensity may include: sharpening the sample object based on the reference sharpening intensity, and performing a plurality of compression encoding on a sharpened sample object, to obtain a plurality of encoded objects corresponding to the sample object; performing quality assessment on each encoded object to obtain a quality assessment indicator value corresponding to each encoded object; and determining the first rate-distortion curve of the sample object at the reference sharpening intensity based on bit information and the quality assessment indicator value that correspond to each encoded object.

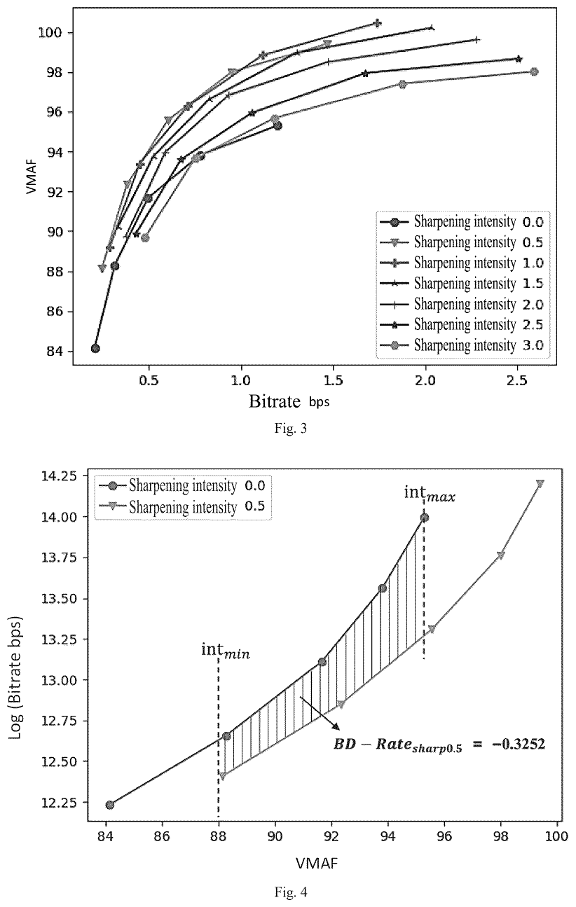

Specifically, if the reference sharpening intensity is 0, no sharpening is required, and a plurality of compression encoding may be performed on the sample object by directly using a plurality of different compression ratios, to obtain an encoded object after each encoding. By performing quality assessment and bit calculation on each encoded object, the quality assessment indicator value and the bit information that correspond to each encoded object are obtained. Coordinate points corresponding to each encoded object are plotted by using the bit information as an abscissa and using the quality assessment indicator value as an ordinate, and the coordinate points are connected to obtain the first rate-distortion curve of the sample object at the reference sharpening intensity. Referring to FIG. 3, when the sample object is a sample video, the corresponding bit information is bitrate, and the quality assessment indicator value is a VMAF, five different compression ratios, which are respectively 21, 24, 27, 30, and 33 (equivalent to five different encoders), are used to perform five compression encoding on the sample object that is sharpened by using the reference sharpening intensity of 0, so that five different coordinate points can be obtained and then connected to obtain the first rate-distortion curve corresponding to the reference sharpening intensity of 0.

For example, the determining a second rate-distortion curve of the sample object at each preset sharpening intensity may include: sharpening the sample object based on each preset sharpening intensity, and performing a plurality of compression encoding on a sharpened sample object, to obtain a plurality of encoded objects corresponding to the sample object; performing quality assessment on each encoded object to obtain a quality assessment indicator value corresponding to each encoded object; and determining the second rate-distortion curve of the sample object at each preset sharpening intensity based on bit information and the quality assessment indicator value that correspond to each encoded object.

Specifically, similar to the reference sharpening intensity, for each preset sharpening intensity, the sample object is sharpened by using the preset sharpening intensity, and a plurality of compression encoding is performed on the sharpened sample object by using a plurality of different compression ratios, so that an encoded object after each time of encoding is obtained. By performing quality assessment and bit calculation on each encoded object, by performing quality assessment and bit calculation on each encoded object, the quality assessment indicator value and the bit information that correspond to each encoded object are obtained. A coordinate point corresponding to each encoded object is plotted by using the bit information as an abscissa and using the quality assessment indicator value as an ordinate, and the coordinate points are connected to obtain the second rate-distortion curve of the sample object at the preset sharpening intensity. Referring to FIG. 3, when the sample object is a sample video, the corresponding bit information is the bitrate, and the quality assessment indicator value is a VMAF, five different compression ratios, which are respectively 21, 24, 27, 30, and 33 (equivalent to five different encoders), are used to perform five compression encoding on the sample object that is sharpened by using each preset sharpening intensity, so that five different coordinate points can be obtained and are connected, to obtain the second rate-distortion curve corresponding to each preset sharpening intensity.

S220: Determining a rate-distortion performance indicator value for each preset sharpening intensity relative to the reference sharpening intensity based on the first rate-distortion curve and the second rate-distortion curve.

Each rate-distortion performance indicator value may include: a first performance indicator value or a second performance indicator value. The first performance indicator value may be a bit information change amount of the preset sharpening intensity relative to the reference sharpening intensity when the preset sharpening intensity and the reference sharpening intensity correspond to a same quality. The second performance indicator information may be a quality assessment indicator change amount of the preset sharpening intensity relative to the reference sharpening intensity when the preset sharpening intensity and the reference sharpening intensity correspond to the same bit information.

It should be noted that when the first performance indicator value is negative, it indicates that with the same quality, the bit information is decreased and the performance is improved. When the first performance indicator value is positive, it indicates that with the same quality, the bit information is increased and the performance is degraded. When the second performance indicator value is positive, it indicates that with the same bit information, the quality is improved and the performance is improved. When the second performance indicator value is negative, it indicates that with the same bit information, the quality is degraded and the performance is degraded.

Specifically, for each preset sharpening intensity, an area, within an abscissa overlapping range (for example, intmin-intmax), between the first rate-distortion curve corresponding to the reference sharpening intensity and the second rate-distortion curve corresponding to the preset sharpening intensity (i.e., an integral difference within the abscissa overlapping range) may be calculated; the area is divided by an abscissa length corresponding to the abscissa overlapping range (i.e., a difference value of intmax minus intmin); and a division result is used as the rate-distortion performance indicator value corresponding to the preset sharpening intensity. Referring to FIG. 4, when the rate-distortion performance indicator value is the first performance indicator value, coordinate transformation is performed on the first rate-distortion curve corresponding to the reference sharpening intensity of 0 and the second rate-distortion curve corresponding to the preset sharpening intensity of 0.5 in FIG. 3, to obtain two transformed curves that use a VMAF as an abscissa and use a log (bitrate) as an ordinate. An area of the two curves within the abscissa overlapping range intmin-intmax (for example, the shaded part in FIG. 4) is calculated, and the area is divided by the abscissa length corresponding to the abscissa overlapping range. An obtained division result is the first performance indicator value corresponding to the preset sharpening intensity of 0.5, namely, BD-Ratesharp0.5=−0.3252, which means that 32.52% of the bitrate can be reduced when the quality at the preset sharpening intensity of 0.5 and the quality at the reference sharpening intensity of 0 are the same.

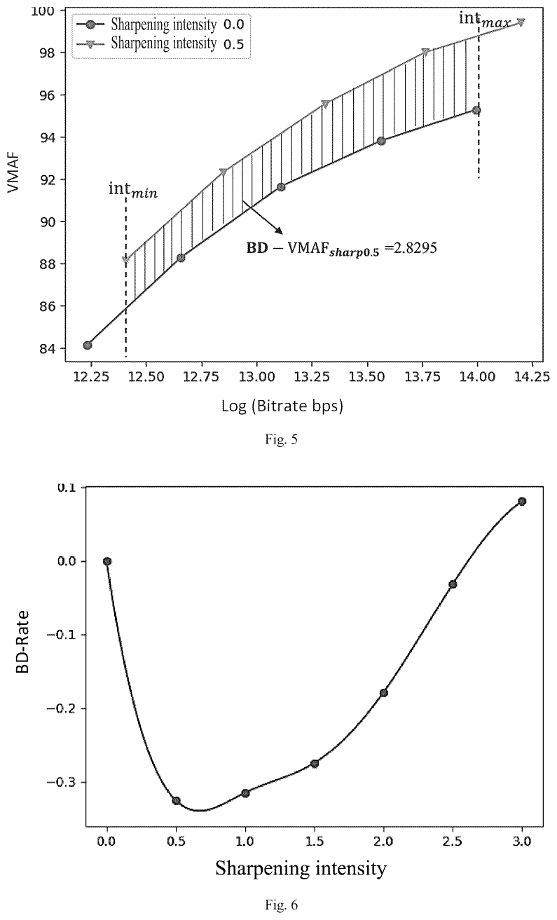

Referring to FIG. 5, when the rate-distortion performance indicator value is the second performance indicator value, the first rate-distortion curve corresponding to the reference sharpening intensity of 0 in FIG. 3 and the second rate-distortion curve corresponding to the preset sharpening intensity of 0.5 are subjected to coordinate transformation, to obtain two transformed curves that use log (bitrate) as abscissa and use a VMAF as an ordinate. An area of the two curves within the abscissa overlapping range intmin-intmax (for example, the shaded part in FIG. 5) is calculated, and the area is divided by the abscissa length corresponding to the abscissa overlapping range. An obtained division result is the second performance indicator value corresponding to the preset sharpening intensity of 0.5, namely, BD-VMAFsharp 0.5=2.8295, which means that the quality assessment indicator value can be increased by 2.8295 when the bitrate at the preset sharpening intensity of 0.5 and the bitrate at the reference sharpening intensity of 0 are the same.

It should be noted that if the transformed curve corresponding to the preset sharpening intensity is below the transformed curve corresponding to the reference sharpening intensity, the calculated rate-distortion performance indicator value is negative. If the transformed curve corresponding to the preset sharpening intensity is above the transformed curve corresponding to the reference sharpening intensity, the calculated rate-distortion performance indicator value is positive.

S230: Determining the sharpening intensity label corresponding to the sample object based on the rate-distortion performance indicator value corresponding to each preset sharpening intensity.

Specifically, the rate-distortion performance indicator values corresponding to the preset sharpening intensities may be compared, and a preset sharpening intensity with highest performance may be used as the sharpening intensity label. Alternatively, curve fitting may be performed based on all the rate-distortion performance indicator values corresponding to all the preset sharpening intensities to obtain a fitted curve between the preset sharpening intensities and the rate-distortion performance indicator values, and a sharpening intensity with highest performance in the fitted curve may be used as the sharpening intensity label. For example, referring to FIG. 6, when the rate-distortion performance indicator value is the first performance indicator value, curve fitting is performed on the first performance indicator value that is obtained by using the method in FIG. 3 and FIG. 4 and corresponds to each preset sharpening intensity, to obtain a fitted curve between the sharpening intensity and the first performance indicator value. A smaller first performance indicator value indicates that larger bitrate is reduced, so that a sharpening intensity corresponding to a minimum first performance indicator value in the fitted curve can be used as the sharpening intensity label corresponding to the sample object.

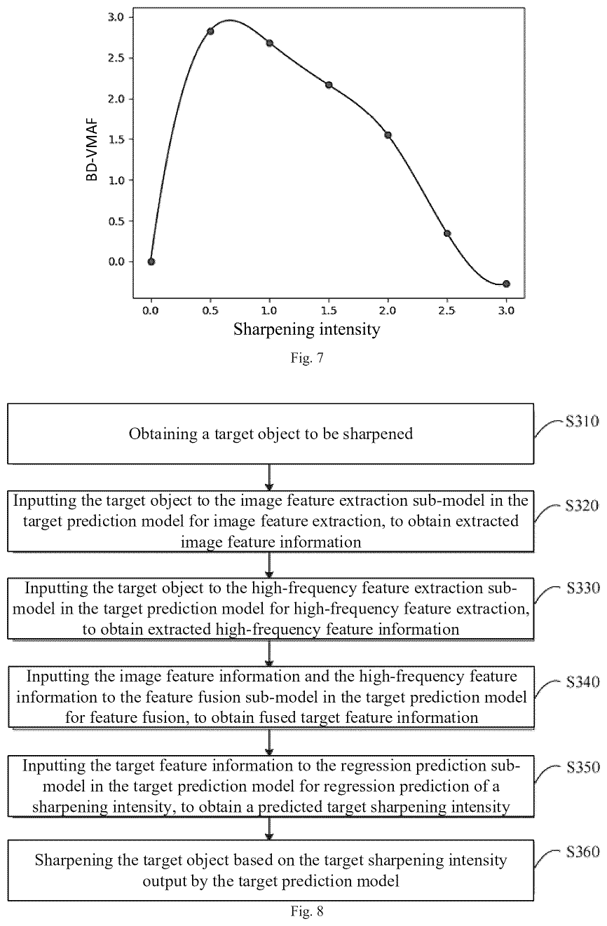

For another example, referring to FIG. 7, when the rate-distortion performance indicator value is the second performance indicator value, curve fitting is performed on the second performance indicator value that is obtained by using the method in FIG. 3 and FIG. 5 and corresponds to each preset sharpening intensity, to obtain a fitted curve between the sharpening intensity and the second performance indicator value. A larger second performance indicator value indicates higher quality of the video, so that a sharpening intensity corresponding to a maximum second performance indicator value in the fitted curve can be used as the sharpening intensity label corresponding to the sample object.

For example, S230 may include: in response to the rate-distortion performance indicator value being the first performance indicator value, determining a preset sharpening intensity corresponding to a smallest first performance indicator value as the sharpening intensity label corresponding to the sample object; or in response to the rate-distortion performance indicator value being the second performance indicator value, determining a preset sharpening intensity corresponding to a largest first performance indicator value as the sharpening intensity label corresponding to the sample object.

Specifically, reference is made to the rate-distortion performance indicator value corresponding to each preset sharpening intensity in FIG. 6 or FIG. 7. Relative to the reference sharpening intensity of 0, the preset sharpening intensity of 0.5 is a sharpening intensity at which the bitrate is reduced most and the quality is the highest. Thus, the preset sharpening intensity of 0.5 may be directly used as the sharpening intensity label corresponding to the sample object.

S240: Obtaining a target prediction model by training based on the sample object and the sharpening intensity label corresponding to the sample object.

S250: Inputting a target object to be sharpened to the target prediction model for prediction of a sharpening intensity.

S260: Sharpening the target object based on a target sharpening intensity output by the target prediction model.

According to the technical solution of this embodiment of the present disclosure, the rate-distortion performance indicator value for each preset sharpening intensity relative to the reference sharpening intensity can be accurately determined based on the first rate-distortion curve of the sample object at the reference sharpening intensity and the second rate-distortion curve of the sample object at each preset sharpening intensity, and the optimal sharpening intensity can be selected as the sharpening intensity label based on the rate-distortion performance indicator value corresponding to each preset sharpening intensity. Thus, this can improve accuracy of predicting the optimal sharpening intensity by the model, then improve quality of the object, and reduce bandwidth consumption.

FIG. 8 is a schematic flowchart of still another sharpening method according to an embodiment of the present disclosure. Based on the above disclosed embodiment, the target prediction model in this embodiment of the present disclosure may include: an image feature extraction sub-model, a high-frequency feature extraction sub-model, a feature fusion sub-model, and a regression prediction sub-model. For the target prediction model, a prediction process of a sharpening intensity is described in detail. Explanations of the terms identical or corresponding to those in the embodiments disclosed above are not repeated herein.

As shown in FIG. 8, the sharpening method specifically includes the following steps.

S310: Obtaining a target object to be sharpened.

S320: Inputting the target object to the image feature extraction sub-model in the target prediction model for image feature extraction, to obtain extracted image feature information.

The image feature information may be complex feature information including bit information and quality information. The image feature extraction sub-model may include a lightweight multilayer convolutional neural network for efficient extraction of the image feature information.

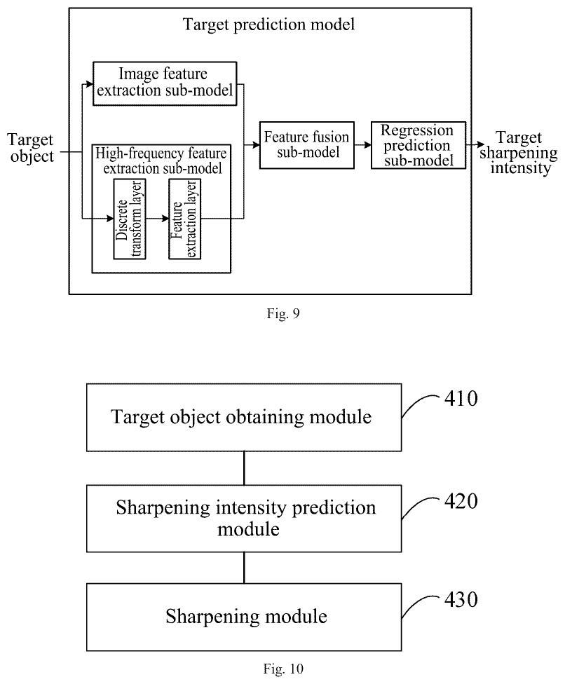

Specifically, referring to FIG. 9, the target object may be input to the image feature extraction sub-model in the target prediction model for efficient extraction of a complex feature. The image feature extraction sub-model may output the extracted image feature information including the bit information and the quality information.

S330: Inputting the target object to the high-frequency feature extraction sub-model in the target prediction model for high-frequency feature extraction, to obtain extracted high-frequency feature information.

The high-frequency feature information may be edge information in the target object. Sharpening the target object is to sharpen the edge information in the target object, to make the edge information clearer. In a spectrum, the edge information is equivalent to high-frequency information.

Specifically, referring to FIG. 9, the target object may also be input to the high-frequency feature extraction sub-model in the target prediction model for high-frequency feature extraction. The high-frequency feature extraction sub-model outputs the extracted high-frequency feature information including the edge information. The edge information in the target object may be obtained by extracting the high-frequency feature information, so that the model can more accurately predict an optimal sharpening intensity based on the edge information.

For example, referring to FIG. 9, the high-frequency feature extraction sub-model may include: a discrete transform layer and a feature extraction layer. The discrete transform layer is a module for performing discrete cosine transform (DCT) and inverse discrete cosine transform (IDCT) on the target object to extract a high-frequency component. The feature extraction layer may perform high-frequency feature extraction and dimensional transformation on extracted high-frequency component information, so that the extracted high-frequency feature information and the image feature information have the same dimensions for subsequent feature fusion.

For example, referring to FIG. 9, S330 may include: inputting the target object to the discrete transform layer for discrete cosine transform (DCT) and inverse discrete cosine transform (IDCT), to obtain high-frequency component information in the target object; and inputting the high-frequency component information to the feature extraction layer for high-frequency feature extraction, to obtain the extracted high-frequency feature information.

S340: Inputting the image feature information and the high-frequency feature information to the feature fusion sub-model in the target prediction model for feature fusion, to obtain fused target feature information.

Specifically, referring to FIG. 9, the feature fusion sub-model may perform feature fusion on the input image feature information and the input high-frequency feature information based on any fusion mode. For example, the feature fusion sub-model may perform weighted summation on the input image feature information and the input high-frequency feature information, and use an obtained summation result as the target feature information.

For example, S340 may include: inputting the image feature information and the high-frequency feature information to the feature fusion sub-model for residual-connection weighted fusion, to obtain the fused target feature information.

Specifically, the feature fusion sub-model may be a residual connection sub-model which performs weighted fusion by residual connection, so that overfitting can be reduced, and gradient disappearance can be prevented. For example, the feature fusion sub-model may multiply the input image feature information by the input high-frequency feature information, add a multiplication result together with the image feature information, and use an obtained adding result as the fused target feature information, thus implementing the residual-connection weighted fusion.

S350: Inputting the target feature information to the regression prediction sub-model in the target prediction model for regression prediction of a sharpening intensity, to obtain a predicted target sharpening intensity.

The regression prediction sub-model may be a non-linear regression network for predicting a final sharpening intensity. Specifically, referring to FIG. 9, the target feature information may be input to the regression prediction sub-model for regression prediction of the optimal sharpening intensity, and the predicted target sharpening intensity may be output.

S360: Sharpening the target object based on the target sharpening intensity output by the target prediction model.

According to the technical solution of this embodiment of the present disclosure, by adding the high-frequency feature extraction sub-model into the target prediction model, the extracted high-frequency feature information and the extracted image feature information can be used to more accurately predict the optimal sharpening intensity, thereby ensuring a balance between quality of the object and bandwidth consumption.

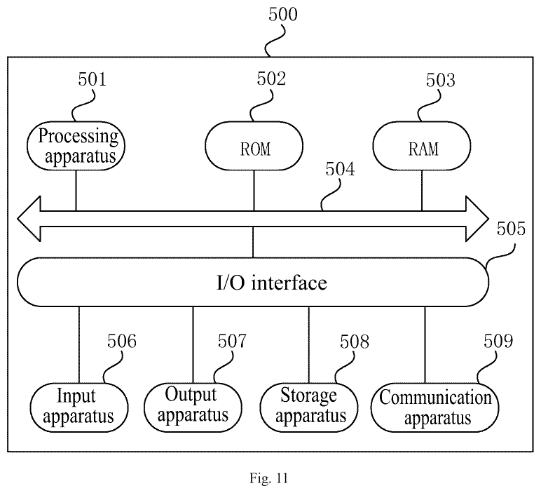

FIG. 10 is a schematic structural diagram of a sharpening apparatus according to an embodiment of the present disclosure. As shown in FIG. 10, the apparatus specifically includes: a target object obtaining module 410, a sharpening intensity prediction module 420, and a sharpening module 430.

The target object obtaining module 410 is configured to obtain a target object to be sharpened. The sharpening intensity prediction module 420 is configured to input the target object to a target prediction model for prediction of a sharpening intensity, where the target prediction model is obtained in advance by training based on a sample object and a sharpening intensity label corresponding to the sample object, and the sharpening intensity label is determined based on rate-distortion performance indicator values corresponding to a plurality of preset sharpening intensities. The sharpening module 430 is configured to sharpen the target object based on a target sharpening intensity output by the target prediction model.

Based on the above technical solution, the apparatus further includes:
a rate-distortion curve determining module, configured to determine a first rate-distortion curve of the sample object at a reference sharpening intensity and a second rate-distortion curve of the sample object at each preset sharpening intensity;
a rate-distortion performance indicator value determining module, configured to determine a rate-distortion performance indicator value for each preset sharpening intensity relative to the reference sharpening intensity based on the first rate-distortion curve and the second rate-distortion curve; and
a sharpening intensity label determining module, configured to determine the sharpening intensity label corresponding to the sample object based on the rate-distortion performance indicator value corresponding to each preset sharpening intensity.

Based on the above technical solutions, the rate-distortion curve determining module is specifically configured to:
sharpen the sample object based on the reference sharpening intensity, and performing a plurality of compression encoding on a sharpened sample object, to obtain a plurality of encoded objects corresponding to the sample object; perform quality assessment on each encoded object to obtain a quality assessment indicator value corresponding to each encoded object; and determine the first rate-distortion curve of the sample object at the reference sharpening intensity based on bit information and the quality assessment indicator value that correspond to each encoded object.

Based on the above technical solutions, when the sample object is a video object, the bit information corresponding to each encoded object is a quantity of bits transmitted per unit time; and when the sample object is a sample image, the bit information corresponding to each encoded object is a quantity of bits corresponding to a single pixel.

Based on the above technical solutions, the rate-distortion performance indicator value includes: a first performance indicator value or a second performance indicator value.

The first performance indicator value is a bit information change amount of the preset sharpening intensity relative to the reference sharpening intensity when the preset sharpening intensity and the reference sharpening intensity correspond to a same quality.

The second performance indicator value is a quality assessment indicator change amount of the preset sharpening intensity relative to the reference sharpening intensity when the preset sharpening intensity and the reference sharpening intensity correspond to the same bit information Based on the above technical solutions, the sharpening intensity label determining module is specifically configured to:
in response to the rate-distortion performance indicator value being the first performance indicator value, determining a preset sharpening intensity corresponding to a smallest first performance indicator value as the sharpening intensity label corresponding to the sample object; or
in response to the rate-distortion performance indicator value being the second performance indicator value, determining a preset sharpening intensity corresponding to a largest first performance indicator value as the sharpening intensity label corresponding to the sample object.

Based on the above technical solutions, the target prediction model includes: an image feature extraction sub-model, a high-frequency feature extraction sub-model, a feature fusion sub-model, and a regression prediction sub-model.

The sharpening intensity prediction module 420 includes:
an image feature information extraction unit, configured to input the target object to the image feature extraction sub-model for image feature extraction, to obtain extracted image feature information;
a high-frequency feature information extraction unit, configured to input the target object to the high-frequency feature extraction sub-model for high-frequency feature extraction, to obtain extracted high-frequency feature information;
a feature information fusion unit, configured to input the image feature information and the high-frequency feature information to the feature fusion sub-model for feature fusion, to obtain fused target feature information; and
a sharpening intensity prediction unit, configured to input the target feature information to the regression prediction sub-model for regression prediction of the sharpening intensity, to obtain a predicted target sharpening intensity.

Based on the above technical solutions, the high-frequency feature extraction sub-model includes: a discrete transform layer and a feature extraction layer.

The high-frequency feature information extraction unit is specifically configured to:
input the target object to the discrete transform layer for discrete cosine transform and inverse discrete cosine transform, to obtain high-frequency component information in the target object; and input the high-frequency component information to the feature extraction layer for high-frequency feature extraction, to obtain the extracted high-frequency feature information.

Based on the above technical solutions, the feature information fusion unit is specifically configured to: input the image feature information and the high-frequency feature information to the feature fusion sub-model for residual-connection weighted fusion, to obtain the fused target feature information.

The sharpening apparatus provided in this embodiment of the present disclosure can perform the sharpening method provided in any one of the embodiments of the present disclosure, and has corresponding functional modules and beneficial effects for performing the sharpening method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

FIG. 11 is a schematic structural diagram of an electronic device according to an embodiment of the present disclosure. Reference is made to FIG. 11 below, which is a schematic structural diagram of an electronic device (such as a terminal device or a server in FIG. 11) 500 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 11 is merely an example, and shall not impose any limitation on the function and scope of use of the embodiments of the present disclosure.

As shown in FIG. 11, the electronic device 500 may include a processing apparatus (for example, a central processing unit or a graphics processing unit) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 11 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the sharpening method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, causes the sharpening method according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium including or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code included in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be included in the above electronic device. Alternatively, the computer-readable medium may exist independently, without being assembled into the electronic device.

The above computer-readable medium carries one or more programs that, when executed by the electronic device, cause the electronic device to: obtain a target object to be sharpened; input the target object to a target prediction model for prediction of a sharpening intensity, where the target prediction model is obtained in advance by training based on a sample object and a sharpening intensity label corresponding to the sample object, and the sharpening intensity label is determined based on rate-distortion performance indicator values corresponding to a plurality of preset sharpening intensities; and sharpen the target object based on a target sharpening intensity output by the target prediction model.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code includes one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may include or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a sharpening method is provided, and the method includes:
obtaining a target object to be sharpened;
inputting the target object to a target prediction model for prediction of a sharpening intensity, where the target prediction model is obtained in advance by training based on a sample object and a sharpening intensity label corresponding to the sample object, and the sharpening intensity label is determined based on rate-distortion performance indicator values corresponding to a plurality of preset sharpening intensities; and
sharpening the target object based on a target sharpening intensity output by the target prediction model.

According to one or more embodiments of the present disclosure, a sharpening method is provided, further including:
optionally, determining the sharpening intensity label corresponding to the sample object based on the rate-distortion performance indicator values corresponding to the plurality of preset sharpening intensities includes:
determining a first rate-distortion curve of the sample object at a reference sharpening intensity and a second rate-distortion curve of the sample object at each preset sharpening intensity;
determining a rate-distortion performance indicator value for each preset sharpening intensity relative to the reference sharpening intensity based on the first rate-distortion curve and the second rate-distortion curve; and
determining the sharpening intensity label corresponding to the sample object based on the rate-distortion performance indicator value corresponding to each preset sharpening intensity.

According to one or more embodiments of the present disclosure, a sharpening method is provided, further including:
optionally, the determining a first rate-distortion curve of the sample object at a reference sharpening intensity includes:
sharpening the sample object based on the reference sharpening intensity, and performing a plurality of compression encoding on a sharpened sample object, to obtain a plurality of encoded objects corresponding to the sample object;
performing quality assessment on each encoded object to obtain a quality assessment indicator value corresponding to each encoded object; and
determining the first rate-distortion curve of the sample object at the reference sharpening intensity based on bit information and the quality assessment indicator value that correspond to each encoded object.

According to one or more embodiments of the present disclosure, a sharpening method is provided, further including:
optionally, when the sample object is a video object, the bit information corresponding to each encoded object is a quantity transmitted per unit time; and
when the sample object is a sample image, the bit information corresponding to the encoded object is a number of bits corresponding to a single pixel.

According to one or more embodiments of the present disclosure, a sharpening method is provided, further including:
optionally, the rate-distortion performance indicator value includes: a first performance indicator value or a second performance indicator value;
the first performance indicator value is a bit information change amount of the preset sharpening intensity relative to the reference sharpening intensity when the preset sharpening intensity and the reference sharpening intensity correspond to a same quality; and
the second performance indicator value is a quality assessment indicator change amount of the preset sharpening intensity relative to the reference sharpening intensity when the preset sharpening intensity and the reference sharpening intensity correspond to the same bit information.

According to one or more embodiments of the present disclosure, a sharpening method is provided, further including:
optionally, the determining the sharpening intensity label corresponding to the sample object based on the rate-distortion performance indicator value corresponding to each preset sharpening intensity includes:
in response to the rate-distortion performance indicator value being the first performance indicator value, determining a preset sharpening intensity corresponding to a smallest first performance indicator value as the sharpening intensity label corresponding to the sample object; or
in response to the rate-distortion performance indicator value being the second performance indicator value, determining a preset sharpening intensity corresponding to a largest first performance indicator value as the sharpening intensity label corresponding to the sample object.

According to one or more embodiments of the present disclosure, a sharpening method is provided, further including:
optionally, the target prediction model includes: an image feature extraction sub-model, a high-frequency feature extraction sub-model, a feature fusion sub-model, and a regression prediction sub-model.

The inputting the target object to a target prediction model for prediction of a sharpening intensity includes:
inputting the target object to the image feature extraction sub-model for image feature extraction, to obtain extracted image feature information;
inputting the target object to the high-frequency feature extraction sub-model for high-frequency feature extraction, to obtain extracted high-frequency feature information;
inputting the image feature information and the high-frequency feature information to the feature fusion sub-model for feature fusion, to obtain fused target feature information; and
inputting the target feature information to the regression prediction sub-model for regression prediction of the sharpening intensity, to obtain a predicted target sharpening intensity.

According to one or more embodiments of the present disclosure, a sharpening method is provided, further including:
optionally, the high-frequency feature extraction sub-model includes: a discrete transform layer and a feature extraction layer;
the inputting the target object to the high-frequency feature extraction sub-model for high-frequency feature extraction, to obtain extracted high-frequency feature information includes:
inputting the target object to the discrete transform layer for discrete cosine transform and inverse discrete cosine transform, to obtain high-frequency component information in the target object; and
inputting the high-frequency component information to the feature extraction layer for high-frequency feature extraction, to obtain the extracted high-frequency feature information.

According to one or more embodiments of the present disclosure, a sharpening method is provided, further including:
optionally, the inputting the image feature information and the high-frequency feature information to the feature fusion sub-model for feature fusion, to obtain fused target feature information includes:
inputting the image feature information and the high-frequency feature information to the feature fusion sub-model for residual-connection weighted fusion, to obtain the fused target feature information.

According to one or more embodiments of the present disclosure, a sharpening apparatus is provided, including:
a target object obtaining module, configured to obtain a target object to be sharpened;
a sharpening intensity prediction module, configured to input the target object to a target prediction model for prediction of a sharpening intensity, where the target prediction model is obtained in advance by training based on a sample object and a sharpening intensity label corresponding to the sample object, and the sharpening intensity label is determined based on rate-distortion performance indicator values corresponding to a plurality of preset sharpening intensities; and
a sharpening module, configured to sharpen the target object based on a target sharpening intensity output by the target prediction model.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A sharpening method, comprising:
obtaining a first object to be sharpened;
inputting the first object to a first prediction model for prediction of a sharpening intensity, wherein the first prediction model is obtained in advance by training based on a sample object and a sharpening intensity label corresponding to the sample object, and the sharpening intensity label is determined based on rate-distortion performance indicator values corresponding to a plurality of preset sharpening intensities; and
sharpening the first object based on a first sharpening intensity output by the first prediction model.

2. The sharpening method according to claim 1, wherein determining the sharpening intensity label corresponding to the sample object based on the rate-distortion performance indicator values corresponding to the plurality of preset sharpening intensities comprises:
determining a first rate-distortion curve of the sample object at a reference sharpening intensity and a second rate-distortion curve of the sample object at each preset sharpening intensity;
determining a rate-distortion performance indicator value for each preset sharpening intensity relative to the reference sharpening intensity based on the first rate-distortion curve and the second rate-distortion curve; and
determining the sharpening intensity label corresponding to the sample object based on the rate-distortion performance indicator value corresponding to each preset sharpening intensity.

3. The sharpening method according to claim 2, wherein the determining a first rate-distortion curve of the sample object at a reference sharpening intensity comprises:
sharpening the sample object based on the reference sharpening intensity, and performing a plurality of compression encoding on a sharpened sample object, to obtain a plurality of encoded objects corresponding to the sample object;
performing quality assessment on each encoded object to obtain a quality assessment indicator value corresponding to each encoded object; and
determining the first rate-distortion curve of the sample object at the reference sharpening intensity based on bit information and the quality assessment indicator value that correspond to each encoded object.

4. The sharpening method according to claim 3, wherein when the sample object is a video object, the bit information corresponding to the encoded object is a number of bits transmitted per unit time; and
when the sample object is a sample image, the bit information corresponding to the encoded object is a number of bits corresponding to a single pixel.

5. The sharpening method according to claim 2, wherein the rate-distortion performance indicator value comprises: a first performance indicator value or a second performance indicator value,
wherein the first performance indicator value is a bit information change amount of the preset sharpening intensity relative to the reference sharpening intensity when the preset sharpening intensity and the reference sharpening intensity correspond to a same quality; and
the second performance indicator value is a quality assessment indicator change amount of the preset sharpening intensity relative to the reference sharpening intensity when the preset sharpening intensity and the reference sharpening intensity correspond to the same bit information.

6. The sharpening method according to claim 5, wherein the determining the sharpening intensity label corresponding to the sample object based on the rate-distortion performance indicator value corresponding to each preset sharpening intensity comprises:
in response to the rate-distortion performance indicator value being the first performance indicator value, determining a preset sharpening intensity corresponding to a smallest first performance indicator value as the sharpening intensity label corresponding to the sample object; or
in response to the rate-distortion performance indicator value being the second performance indicator value, determining a preset sharpening intensity corresponding to a largest first performance indicator value as the sharpening intensity label corresponding to the sample object.

7. The sharpening method according to claim 1, wherein the first prediction model comprises: an image feature extraction sub-model, a high-frequency feature extraction sub-model, a feature fusion sub-model, and a regression prediction sub-model; and
the inputting the first object to a first prediction model for prediction of a sharpening intensity comprises:
inputting the first object to the image feature extraction sub-model for image feature extraction, to obtain extracted image feature information;
inputting the first object to the high-frequency feature extraction sub-model for high-frequency feature extraction, to obtain extracted high-frequency feature information;
inputting the image feature information and the high-frequency feature information to the feature fusion sub-model for feature fusion, to obtain fused first feature information; and
inputting the first feature information to the regression prediction sub-model for regression prediction of the sharpening intensity, to obtain a predicted first sharpening intensity.

8. The sharpening method according to claim 7, wherein the high-frequency feature extraction sub-model comprises: a discrete transform layer and a feature extraction layer; and
the inputting the first object to the high-frequency feature extraction sub-model for high-frequency feature extraction, to obtain extracted high-frequency feature information comprises:
inputting the first object to the discrete transform layer for discrete cosine transform and inverse discrete cosine transform, to obtain high-frequency component information in the first object; and
inputting the high-frequency component information to the feature extraction layer for high-frequency feature extraction, to obtain the extracted high-frequency feature information.

9. The sharpening method according to claim 7, wherein the inputting the image feature information and the high-frequency feature information to the feature fusion sub-model for feature fusion, to obtain fused first feature information comprises:
inputting the image feature information and the high-frequency feature information to the feature fusion sub-model for residual-connection weighted fusion, to obtain the fused first feature information.

10. (canceled)

11. An electronic device, comprising:
one or more processors; and
a storage apparatus, configured to store one or more programs, wherein the one or more programs, when executed by the one or more processors, cause the one or more processors to implement a sharpening method, and the sharpening method comprises:
obtaining a first object to be sharpened;
inputting the first object to a first prediction model for prediction of a sharpening intensity, wherein the first prediction model is obtained in advance by training based on a sample object and a sharpening intensity label corresponding to the sample object, and the sharpening intensity label is determined based on rate-distortion performance indicator values corresponding to a plurality of preset sharpening intensities; and
sharpening the first object based on a first sharpening intensity output by the first prediction model.

12. non-transitory storage medium comprising computer-executable instructions, wherein the computer-executable instructions, when executed by a processor of a computer, are configured to perform a sharpening method, and the sharpening method comprises:
obtaining a first object to be sharpened;
inputting the first object to a first prediction model for prediction of a sharpening intensity, wherein the first prediction model is obtained in advance by training based on a sample object and a sharpening intensity label corresponding to the sample object, and the sharpening intensity label is determined based on rate-distortion performance indicator values corresponding to a plurality of preset sharpening intensities; and
sharpening the first object based on a first sharpening intensity output by the first prediction model.

13. The electronic device according to claim 11, wherein determining the sharpening intensity label corresponding to the sample object based on the rate-distortion performance indicator values corresponding to the plurality of preset sharpening intensities comprises:
determining a first rate-distortion curve of the sample object at a reference sharpening intensity and a second rate-distortion curve of the sample object at each preset sharpening intensity;
determining a rate-distortion performance indicator value for each preset sharpening intensity relative to the reference sharpening intensity based on the first rate-distortion curve and the second rate-distortion curve; and
determining the sharpening intensity label corresponding to the sample object based on the rate-distortion performance indicator value corresponding to each preset sharpening intensity.

14. The electronic device according to claim 13, wherein the determining a first rate-distortion curve of the sample object at a reference sharpening intensity comprises:
sharpening the sample object based on the reference sharpening intensity, and performing a plurality of compression encoding on a sharpened sample object, to obtain a plurality of encoded objects corresponding to the sample object;
performing quality assessment on each encoded object to obtain a quality assessment indicator value corresponding to each encoded object; and
determining the first rate-distortion curve of the sample object at the reference sharpening intensity based on bit information and the quality assessment indicator value that correspond to each encoded object.

15. The electronic device according to claim 14, wherein when the sample object is a video object, the bit information corresponding to the encoded object is a number of bits transmitted per unit time; and
when the sample object is a sample image, the bit information corresponding to the encoded object is a number of bits corresponding to a single pixel.

16. The electronic device according to claim 13, wherein the rate-distortion performance indicator value comprises: a first performance indicator value or a second performance indicator value,
wherein the first performance indicator value is a bit information change amount of the preset sharpening intensity relative to the reference sharpening intensity when the preset sharpening intensity and the reference sharpening intensity correspond to a same quality; and
the second performance indicator value is a quality assessment indicator change amount of the preset sharpening intensity relative to the reference sharpening intensity when the preset sharpening intensity and the reference sharpening intensity correspond to the same bit information.

17. The electronic device according to claim 16, wherein the determining the sharpening intensity label corresponding to the sample object based on the rate-distortion performance indicator value corresponding to each preset sharpening intensity comprises:
in response to the rate-distortion performance indicator value being the first performance indicator value, determining a preset sharpening intensity corresponding to a smallest first performance indicator value as the sharpening intensity label corresponding to the sample object; or
in response to the rate-distortion performance indicator value being the second performance indicator value, determining a preset sharpening intensity corresponding to a largest first performance indicator value as the sharpening intensity label corresponding to the sample object.

18. The electronic device according to claim 11, wherein the first prediction model comprises: an image feature extraction sub-model, a high-frequency feature extraction sub-model, a feature fusion sub-model, and a regression prediction sub-model; and
the inputting the first object to a first prediction model for prediction of a sharpening intensity comprises:
inputting the first object to the image feature extraction sub-model for image feature extraction, to obtain extracted image feature information;
inputting the first object to the high-frequency feature extraction sub-model for high-frequency feature extraction, to obtain extracted high-frequency feature information;
inputting the image feature information and the high-frequency feature information to the feature fusion sub-model for feature fusion, to obtain fused first feature information; and
inputting the first feature information to the regression prediction sub-model for regression prediction of the sharpening intensity, to obtain a predicted first sharpening intensity.

19. The electronic device according to claim 18, wherein the high-frequency feature extraction sub-model comprises: a discrete transform layer and a feature extraction layer; and
the inputting the first object to the high-frequency feature extraction sub-model for high-frequency feature extraction, to obtain extracted high-frequency feature information comprises:
inputting the first object to the discrete transform layer for discrete cosine transform and inverse discrete cosine transform, to obtain high-frequency component information in the first object; and
inputting the high-frequency component information to the feature extraction layer for high-frequency feature extraction, to obtain the extracted high-frequency feature information.

20. The electronic device according to claim 18, wherein the inputting the image feature information and the high-frequency feature information to the feature fusion sub-model for feature fusion, to obtain fused first feature information comprises:
inputting the image feature information and the high-frequency feature information to the feature fusion sub-model for residual-connection weighted fusion, to obtain the fused first feature information.

21. The non-transitory storage medium according to claim 12, wherein determining the sharpening intensity label corresponding to the sample object based on the rate-distortion performance indicator values corresponding to the plurality of preset sharpening intensities comprises:
determining a first rate-distortion curve of the sample object at a reference sharpening intensity and a second rate-distortion curve of the sample object at each preset sharpening intensity;
determining a rate-distortion performance indicator value for each preset sharpening intensity relative to the reference sharpening intensity based on the first rate-distortion curve and the second rate-distortion curve; and
determining the sharpening intensity label corresponding to the sample object based on the rate-distortion performance indicator value corresponding to each preset sharpening intensity.
